(19) United States
(12) Patent Application Publication
(10) Pub. No.: US 2007/0112445 A1
(43) Pub. Date: May 17, 2007

(54) Quadratic Performance, Infinite Steps, Set Point Model Tracking Controllers

(75) Inventor: KY MINH VU, Ottawa (CA)

Correspondence Address: KY MINH VU, 478-2446 Bank Street, Ottawa, ON, K1V 1A8, CA

(73) Assignee: AULAC TECHNOLOGIES INC., Ottawa (CA)

(21) Appl. No.: 11/534,102

(22) Filed: Sep. 21, 2006

(30) Foreign Application Priority Data
Sep. 28, 2005 (CA) 2,560,037

(51) Int. Cl. G05B 13/02

(52) U.S. Cl. 700/44

(57) ABSTRACT

Two linear quadratic tracking controllers and a minimal prototype controller are presented for the control of a discrete single input and single output (SISO) tracking control system. The minimal prototype controller is an unconstrained controller. Depending on the models of the set point and the plant transfer function, this controller might be desirable. But usually one would choose one of the two linear quadratic controllers which minimize the sum of squared errors between the output and the set point variables with a penalty on that of the input variable. The one degree of freedom (1-DOF) controller performs well, but for nonminimum phase systems the two and a half degrees of freedom (2.5-DOF) controller is the stronger one as it can suppress the inverse response of a non-minimum phase system. The 1-DOF controller gives the stochastic regulating controller counterpart known as the linear quadratic Gaussian controller. A digital control chip for implementation of the controllers is also disclosed.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to control theory and its applications in process control, control of machines and systems. This invention presents a control algorithm that procures a number of controllers. The controllers are called quadratic performance controllers because they obey their quadratic performance indices and infinite steps because optimization involves an infinite number of control actions.

2. Prior Art

The control of a single input and single output (SISO) tracking control system has no satisfactory solution. The usual controllers designed for this system are the PID, dead beat, Dahlin (Dahlin, D. B. (1968) “Designing and Tuning Digital Controllers.”, Instruments & Control Systems, Vol. 41, pp 77-83.), IMC (Garcia, C. E. and Morari, M. “Internal Model Control: 1. A Unifying Review and Some New Results.” Ind. Eng. Chem. Process Des. Dev., 1982, 21, 308-323) and Vogel-Edgar (Vogel, E. F. and Edgar, T. F. (1982) “Application of an Adaptive Pole-Zero Placement Controller to Chemical Processes with Variable Dead Time.” Proc. Amer. Control Conf. June '82) controllers. Even though these controllers can give stable feedback control actions, there are weaknesses in these controllers. One weakness is that they do not have a set point model that can admit a wide range of tracking control problems. The second weakness is that the control design methodology of the controllers is pure intuition. There is no performance index for these controllers, so that one can calculate and compare it with that of other controllers. In the era when the performance of a control loop is assessed regularly and a control index like the Harris index (Harris, T. J. (1989) “Assessment of the Control Loop Performance”, Can. J. Chem. Eng., 67, pp. 856-861.) is suggested for its assessment, these controllers will fall out of favor and a new controller that can answer to these challenges is in demand. The control of an SISO nonminimum phase tracking control system is an even more difficult problem. The process control veteran Shinskey, F. G. classified it as one of the uncontrollable processes. It is known that one cannot design a dead beat or Dahlin controller for this system. Only controllers such as the PID, Vogel-Edgar and IMC can give stable feedback control actions. But their controls are still unsatisfactory, because they cannot prevent the inverse response of a nonminimum phase system. Only a controller with future values of the set point can solve this problem. The current controller that has been used in the process industry a lot is the model predictive controller. From the first application, this controller of Prett, David M. et al. (1982) was used indiscriminatingly as a tracking and regulating controller in (“Dynamic Matrix Control Method”, U.S. Pat. No. 4,349,869). It is easy to see that a model predictive controller should preferably be applied in tracking control, because it is where prediction can be exact and will not incur further error. This idea must have been perceived in the controller of Wassick, J. M. et at. (2000) in (“Model Predictive Controller”, U.S. Pat. No. 6,056,781). In the European continent, we can cite the controller of Attarwala Fakhruddin, T. (2006) in (“Integrated Optimization and Control Using Modular Model Predictive Controller”, UK patent GB2415795A). However, most if not all model predictive controllers in application have a finite control horizon and do not have an infinite of number of future set point values for improvement of the control of a nonminimum phase system. Therefore, they are not as efficient as the controllers of this invention. Because of a suggested set point model for a tracking control system, this invention is also able to obtain a linear quadratic Gaussian controller for a regulating control system due to the duality of the two control models. This invention is the answer to all the challenges of an SISO discrete control system.

### OBJECTS AND ADVANTAGES

It is the object of this invention to introduce three linear controllers for the tracking control of an SISO discrete control system. Each controller is suitable for a particular system.

It is a further object of this invention to introduce a set point model for an SISO tracking control system.

It is a further object of this invention to introduce a performance index for the tracking controllers based on the set point model.

It is a further object of this invention to obtain the equations to calculate the sum of squares for the error variable of a tracking control system for a comparison with that of other controllers or same controller with other settings of some system parameters and for on-line verification of the plant model of the physical system.

It is a further object of this invention to obtain the equations to calculate the sum of squares for the input variable of a tracking control system for a comparison with that of other controllers or same controller with other settings of some system parameters and for on-line verification of the plant model of the physical system.

It is a further object of this invention to obtain a quadratic performance, infinite steps stochastic controller of an SISO regulating control system.

It is a further object of this invention to obtain the equations to calculate the variances for the input and output variables for a comparison with that of other controllers and for on-line verification of the plant and disturbance models.

### SUMMARY

The control algorithm of the new invention is the answer to all current tracking control problems and it is also the solution to the regulating control problem with an equivalent model. By introducing a set point model into a tracking control system model, the invention makes the two tracking and regulating controls equivalent and kills two birds with one stone.

### DRAWINGS

FIG. 1. Block diagram of a tracking control system with its transfer function and disturbance models.

FIG. 2. Block diagram of a regulating control system with its transfer function and disturbance models.

FIG. 3. Block diagram of the physical equipment for the implementation of the controllers.

FIG. 4. Graphs of the responses of the output and input variables of a minimum phase tracking control system.

FIG. 5. Graphs of the responses of the output and input variables of a nonminimum phase tracking control system.

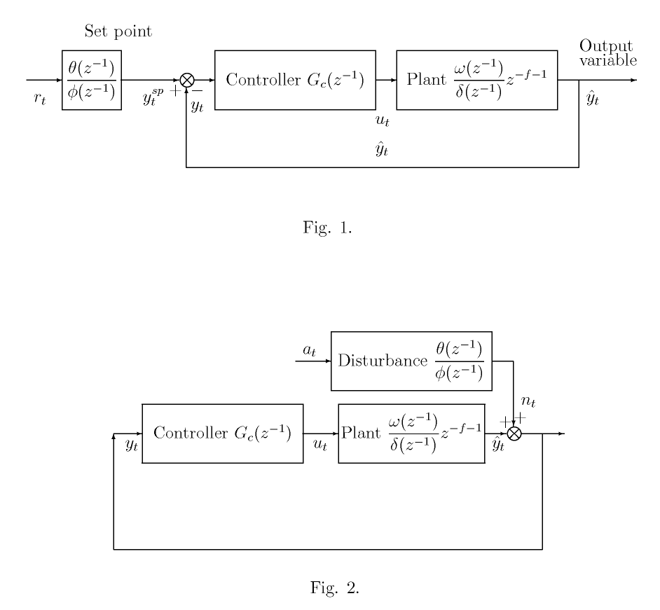

### DETAILED DESCRIPTION FIGS. 1 AND 2—PREFERRED EMBODIMENT

A preferred embodiment of the present invention is the solutions of the control systems illustrated in FIG. 1 and FIG. 2.

The Tracking Control System

A control system must have a disturbance for it to exist. For tracking control the disturbance is a set point change. For efficient control design, the set point change must have a model. For SISO systems the set point change model can be described by a rational transfer function below

$$ϕ ( {z}^{- 1} ) {y}_{t}^{sp} = θ ( {z}^{- 1} ) {r}_{t} , \\ {y}_{t}^{sp} = \frac{θ ( {z}^{- 1} )}{{ϕ}^{*} ( {z}^{- 1} ) {( 1 - {z}^{- 1} )}^{d}} {r}_{t} .$$

The polynomials φ*(z⁻¹) and θ(z⁻¹) are stable and rₜ is a reference variable that is a multiple r of the discrete Dirac delta sequence. this means that we can write

$${y}_{t}^{sp} = r \frac{θ ( {z}^{- 1} )}{{ϕ}^{*} ( {z}^{- 1} ) {( 1 - {z}^{- 1} )}^{d}} {δ}_{t} . \qquad ( 1 )$$

Some set point models for common time functions of a set point change are listed in Table 1. The control system with its models is depicted in FIG. 1.

Now we define the following z-transforms of the variables

$$u ( {z}^{- 1} ) = {\sum }_{k = 0}^{∞} {u}_{k} {z}^{- k} , \\ y ( {z}^{- 1} ) = {\sum }_{k = 0}^{∞} {y}_{k} {z}^{- k} , \\ r ( {z}^{- 1} ) = {\sum }_{k = 0}^{∞} {r}_{k} {z}^{- k} = {r}^{2} , \\ {y}^{sp} ( {z}^{- 1} ) = \frac{θ ( {z}^{- 1} )}{{ϕ}^{*} ( {z}^{- 1} ) {( 1 - {z}^{- 1} )}^{d}} r ( {z}^{- 1} ) .$$

From the block diagram of FIG. 1, we can write the error variable function as below

$$y ( {z}^{- 1} ) = - \frac{ω ( {z}^{- 1} ) {z}^{- f - 1}}{δ ( {z}^{- 1} )} u ( {z}^{- 1} ) + {y}^{sp} ( {z}^{- 1} ) .$$

Since r(z⁻¹) is a constant, we can divide both sides of the above equation by r(z⁻¹) to obtain the following equation:

$$\frac{y ( {z}^{- 1} )}{r ( {z}^{- 1} )} = - \frac{ω ( {z}^{- 1} ) {z}^{- f - 1}}{δ ( {z}^{- 1} ) {( 1 - {z}^{- 1} )}^{d}} \frac{{( 1 - {z}^{- 1} )}^{d} u ( {z}^{- 1} )}{r ( {z}^{- 1} )} + \frac{θ ( {z}^{- 1} )}{{ϕ}^{*} ( {z}^{- 1} ) {( 1 - {z}^{- 1} )}^{d}} .$$

By defining the following Diophantine equation:

$$\frac{θ ( {z}^{- 1} )}{ϕ ( {z}^{- 1} )} = ψ ( {z}^{- 1} ) + \frac{γ ( {z}^{- 1} )}{ϕ ( {z}^{- 1} )} {z}^{- f - 1}$$

and assuming that we have the controller in the following form:
(1−z⁻¹)^{d}u(z⁻¹)=l(z⁻¹)r(z⁻¹,
we can write the following equation:

$$\begin{matrix}\frac{y ( {z}^{- 1} )}{r ( {z}^{- 1} )} = - \frac{ω ( {z}^{- 1} ) {z}^{- f - 1}}{δ ( {z}^{- 1} ) {( 1 - {z}^{- 1} )}^{d}} l ( {z}^{- 1} ) + ψ ( {z}^{- 1} ) + \\ \frac{γ ( {z}^{- 1} )}{{ϕ}^{*} ( {z}^{- 1} ) {( 1 - {z}^{- 1} )}^{d}} {z}^{- f - 1} , \\ = ψ ( {z}^{- 1} ) - \frac{ω ( {z}^{- 1} ) {ϕ}^{*} ( {z}^{- 1} ) l ( {z}^{- 1} ) - δ ( {z}^{- 1} ) γ ( {z}^{- 1} )}{δ ( {z}^{- 1} ) ϕ ( {z}^{- 1} )} {z}^{- f - 1} .\end{matrix} \qquad ( 2 )$$

For a quadratic performance and infinite steps control strategy, we have the optimal performance index given as below

$$\begin{matrix}{\hat{σ}}^{2} = Min {σ}^{2} , \\ = Min \frac{1}{2 π i} {∮}_{C} [ \frac{y ( z ) y ( {z}^{- 1} )}{r ( z ) r ( {z}^{- 1} )} + λ \frac{{( 1 - z )}^{d} u ( z ) {( 1 - {z}^{- 1} )}^{d} u ( {z}^{- 1} )}{r ( z ) r ( {z}^{- 1} )} ] \frac{dz}{z} , \\ = Min {Residue}_{z = 0} [ \frac{y ( z ) y ( {z}^{- 1} )}{r ( z ) r ( {z}^{- 1} )} + λ \frac{{( 1 - z )}^{d} u ( z ) {( 1 - {z}^{- 1} )}^{d} u ( {z}^{- 1} )}{r ( z ) r ( {z}^{- 1} )} ] \frac{1}{z} .\end{matrix} \qquad ( 3 )$$

The positive constant λ is called the penalty constant.

The Minimal Prototype Controller

For the minimal prototype controller or unconstrained controller, the penalty constant in Eq. (3) is zero and we have the performance index as below

$${σ}^{2} = {Residue}_{z = 0} \frac{y ( z ) y ( {z}^{- 1} )}{r ( z ) r ( {z}^{- 1} )} \frac{1}{z} .$$

The controller for this case can be obtained by setting the second term of Eq. (2) to zero. Then we have

$$l ( {z}^{- 1} ) = \frac{δ ( {z}^{- 1} ) γ ( {z}^{- 1} )}{ω ( {z}^{- 1} ) {ϕ}^{*} ( {z}^{- 1} )} .$$

This gives us the sum of squares of the input variable values as below

$$\begin{matrix}{σ}_{u , MP}^{2} = \frac{1}{{r}^{2}} {\sum }_{t = 0}^{∞} {( 1 - {z}^{- 1} )}^{d} {u}_{t}^{2} , \\ = {Residue}_{z = 0} \frac{δ ( z ) γ ( z ) δ ( {z}^{- 1} ) γ ( {z}^{- 1} )}{z ω ( z ) {ϕ}^{*} ( z ) ω ( {z}^{- 1} ) {ϕ}^{*} ( {z}^{- 1} )} .\end{matrix} \qquad ( 4 )$$

If the system is nonminimum phase, the polynomial w(z⁻¹) will be unstable and therefore one will never design this unconstrained controller for this kind of control system. In this case the sum of squares of the output variable values is the same as the optimal performance index, i.e. we have

$$\begin{matrix}{σ}_{y , MP}^{2} = {\hat{σ}}_{MP}^{2} , \\ = {Residue}_{z = 0} ψ ( z ) ψ ( {z}^{- 1} ) \frac{1}{z} .\end{matrix} \qquad ( 5 )$$

The unconstrained controller is occasionally called the output dead beat controller, because it beats the error dead after the dead time of the system. In terms of the input and error variables, we can write the controller from the above equation as follows

$$\begin{matrix}u ( {z}^{- 1} ) = l ( {z}^{- 1} ) \frac{r ( {z}^{- 1} )}{{( 1 - {z}^{- 1} )}^{d}} , \\ = \frac{δ ( {z}^{- 1} ) γ ( {z}^{- 1} )}{ω ( {z}^{- 1} ) ϕ ( {z}^{- 1} )} r ( {z}^{- 1} ) , \\ = \frac{δ ( {z}^{- 1} ) γ ( {z}^{- 1} )}{ω ( {z}^{- 1} ) ϕ ( {z}^{- 1} )} \frac{ϕ ( {z}^{- 1} )}{θ ( {z}^{- 1} )} {y}^{sp} ( {z}^{- 1} ) , \\ = \frac{δ ( {z}^{- 1} ) γ ( {z}^{- 1} )}{ω ( {z}^{- 1} ) θ ( {z}^{- 1} )} [ \hat{y} ( {z}^{- 1} ) + y ( {z}^{- 1} ) ] , \\ = \frac{δ ( {z}^{- 1} ) γ ( {z}^{- 1} )}{ω ( {z}^{- 1} ) θ ( {z}^{- 1} )} [ \frac{ω ( {z}^{- 1} )}{δ ( {z}^{- 1} )} {z}^{- f - 1} u ( {z}^{- 1} ) + y ( {z}^{- 1} ) ] .\end{matrix}$$

By moving the term with the input variable to the left hand side, we can obtain the controller as follows.
or

$$[ 1 - \frac{γ ( {z}^{- 1} ) {z}^{- f - 1}}{θ ( {z}^{- 1} )} ] u ( {z}^{- 1} ) = \frac{δ ( {z}^{- 1} ) γ ( {z}^{- 1} )}{ω ( {z}^{- 1} ) θ ( {z}^{- 1} )} y ( {z}^{- 1} ) , \\ \frac{θ ( {z}^{- 1} ) - γ ( {z}^{- 1} ) {z}^{- f - 1}}{θ ( {z}^{- 1} )} u ( {z}^{- 1} ) = \frac{δ ( {z}^{- 1} ) γ ( {z}^{- 1} )}{ω ( {z}^{- 1} ) θ ( {z}^{- 1} )} y ( {z}^{- 1} ) , \\ \frac{ψ ( {z}^{- 1} ) ϕ ( {z}^{- 1} )}{θ ( {z}^{- 1} )} u ( {z}^{- 1} ) = \frac{δ ( {z}^{- 1} ) γ ( {z}^{- 1} )}{ω ( {z}^{- 1} ) θ ( {z}^{- 1} )} y ( {z}^{- 1} ) , \\ u ( {z}^{- 1} ) = \frac{δ ( {z}^{- 1} ) γ ( {z}^{- 1} )}{ω ( {z}^{- 1} ) ψ ( {z}^{- 1} ) ϕ ( {z}^{- 1} )} y ( {z}^{- 1} ) \\ {u}_{t} = \frac{δ ( {z}^{- 1} ) γ ( {z}^{- 1} )}{ω ( {z}^{- 1} ) ψ ( {z}^{- 1} ) ϕ ( {z}^{- 1} )} {y}_{t} . \qquad ( 6 )$$

The 1-DOF Linear Quadratic Tracking Controller

For this case the controller is constrained and is a function of past values of rₜ only. The performance index for this case is written as below

$${σ}^{2} = {Residue}_{z = 0} [ \frac{y ( z ) y ( {z}^{- 1} )}{r ( z ) r ( {z}^{- 1} )} + λ l ( z ) l ( {z}^{- 1} ) ] \frac{1}{z} .$$

With the performance index obtained, now we can proceed to derive the controller equation for this performance index.

With Eq. (2) above, we can write the performance index as below

$${σ}^{2} = {Residue}_{z = 0} [ ψ ( z ) - \frac{ω ( z ) {ϕ}^{*} ( z ) l ( z ) - δ ( z ) γ ( z )}{σ ( z ) ϕ ( z )} {z}^{f + 1} ] \\ [ ψ ( {z}^{- 1} ) - \frac{ω ( {z}^{- 1} ) {ϕ}^{*} ( {z}^{- 1} ) l ( {z}^{- 1} ) - δ ( {z}^{- 1} ) γ ( {z}^{- 1} )}{δ ( {z}^{- 1} ) ϕ ( {z}^{- 1} )} {z}^{- f - 1} ] \frac{1}{z} + {Residue}_{z = 0} λ l ( z ) l ( {z}^{- 1} ) \frac{1}{z} .$$

The first term in the above equation gives four components. However, the residues of the cross-products are zero and therefore we can write

$${σ}^{2} = {Residue}_{z = 0} [ ψ ( z ) ψ ( {z}^{- 1} ) \frac{1}{z} + [ \frac{\begin{matrix}ω ( z ) {ϕ}^{*} ( z ) l ( z ) - \\ δ ( z ) γ ( z )\end{matrix}}{δ ( z ) ϕ ( z )} ] [ \frac{\begin{matrix}ω ( {z}^{- 1} ) {ϕ}^{*} ( {z}^{- 1} ) l ( {z}^{- 1} ) - \\ δ ( {z}^{- 1} ) γ ( {z}^{- 1} )\end{matrix}}{δ ( {z}^{- 1} ) ϕ ( {z}^{- 1} )} ] \frac{1}{z} + λ \frac{l ( z ) δ ( z ) {ϕ}^{*} ( z ) {( 1 - z )}^{d} δ ( {z}^{- 1} ) {ϕ}^{*} ( {z}^{- 1} ) {( 1 - {z}^{- 1} )}^{d} l ( {z}^{- 1} )}{z δ ( z ) ϕ ( z ) δ ( {z}^{- 1} ) ϕ ( {z}^{- 1} )} ] .$$

By adding the last two terms together, we have

$${σ}^{2} = {Residue}_{z = 0} [ \begin{matrix}ψ ( z ) ψ ( {z}^{- 1} ) \frac{1}{z} + \frac{δ ( z ) γ ( z ) δ ( {z}^{- 1} ) γ ( {z}^{- 1} )}{z δ ( z ) ϕ ( z ) δ ( {z}^{- 1} ) ϕ ( {z}^{- 1} )} + \\ \frac{{ϕ}^{*} ( z ) l ( z ) [ \begin{matrix}ω ( z ) ω ( {z}^{- 1} ) + \\ λδ ( z ) {( 1 - z )}^{d} δ ( {z}^{- 1} ) {( 1 - {z}^{- 1} )}^{d}\end{matrix} ] {ϕ}^{*} ( {z}^{- 1} ) l ( {z}^{- 1} )}{z δ ( z ) ϕ ( z ) δ ( {z}^{- 1} ) ϕ ( {z}^{- 1} )} - \\ \frac{δ ( z ) γ ( z ) ω ( {z}^{- 1} ) {ϕ}^{*} ( {z}^{- 1} ) l ( {z}^{- 1} )}{z δ ( z ) ϕ ( z ) δ ( {z}^{- 1} ) ϕ ( {z}^{- 1} )} - \\ \frac{ω ( z ) {ϕ}^{*} ( z ) l ( z ) δ ( {z}^{- 1} ) γ ( {z}^{- 1} )}{z δ ( z ) ϕ ( z ) δ ( {z}^{- 1} ) ϕ ( {z}^{- 1} )}\end{matrix} ] .$$

Now if we define the following spectral factorization for the terms in the square brackets of the third term
α(z)α(z⁻¹)=w(z)w(z⁻¹)+λδ(z)(1−z)_{d}δ(z⁻¹)(1−z⁻¹)^{d}, (7)
we can rewrite the previous equation as below

$${σ}^{2} = {Residue}_{z = 0} [ \begin{matrix}ψ ( z ) ψ ( {z}^{- 1} ) \frac{1}{z} + \frac{δ ( z ) γ ( z ) δ ( {z}^{- 1} ) γ ( {z}^{- 1} )}{z δ ( z ) ϕ ( z ) δ ( {z}^{- 1} ) ϕ ( {z}^{- 1} )} - \\ \frac{ω ( z ) δ ( z ) γ ( z ) ω ( {z}^{- 1} ) δ ( {z}^{- 1} ) γ ( {z}^{- 1} )}{z δ ( z ) ϕ ( z ) α ( z ) α ( {z}^{- 1} ) δ ( {z}^{- 1} ) ϕ ( {z}^{- 1} )} + \\ \frac{[ {ϕ}^{*} ( z ) l ( z ) - \frac{δ ( z ) γ ( z ) ω ( {z}^{- 1} )}{α ( z ) α ( {z}^{- 1} )} ] α ( z ) α ( {z}^{- 1} ) [ \begin{matrix}{ϕ}^{*} ( {z}^{- 1} ) l ( {z}^{- 1} ) - \\ \frac{δ ( {z}^{- 1} ) γ ( {z}^{- 1} ) ω ( z )}{α ( z ) α ( {z}^{- 1} )}\end{matrix} ]}{z δ ( z ) ϕ ( z ) δ ( {z}^{- 1} ) ϕ ( {z}^{- 1} )}\end{matrix} ] .$$

By using the spectral factorization Eq. (7), we can combine the second and third terms into one to give the final result as

$${σ}^{2} = {Residue}_{z = 0} [ \begin{matrix}ψ ( z ) ψ ( {z}^{- 1} ) \frac{1}{z} + λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ \frac{[ {ϕ}^{*} ( z ) l ( z ) - \frac{δ ( z ) γ ( z ) ω ( {z}^{- 1} )}{α ( z ) α ( {z}^{- 1} )} ] α ( z ) α ( {z}^{- 1} ) [ \begin{matrix}{ϕ}^{*} ( {z}^{- 1} ) l ( {z}^{- 1} ) - \\ \frac{δ ( {z}^{- 1} ) γ ( {z}^{- 1} ) ω ( z )}{α ( z ) α ( {z}^{- 1} )}\end{matrix} ]}{z δ ( z ) ϕ ( z ) δ ( {z}^{- 1} ) ϕ ( {z}^{- 1} )}\end{matrix} ] .$$

The first two terms are constant with respect to l(z⁻¹), so minimization means minimization of the last term which can be simplified as below

$${σ}^{2} = {Residue}_{z = 0} [ \begin{matrix}ψ ( z ) ψ ( {z}^{- 1} ) \frac{1}{z} + λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ [ \begin{matrix}\frac{α ( z ) l ( z )}{δ ( z ) {( 1 - z )}^{d}} - \\ \frac{γ ( z ) ω ( {z}^{- 1} )}{ϕ ( z ) α ( {z}^{- 1} )}\end{matrix} ] [ \begin{matrix}\frac{α ( {z}^{- 1} ) l ( {z}^{- 1} )}{{δ ( 1 - {z}^{- 1} )}^{d}} - \\ \frac{γ ( {z}^{- 1} ) ω ( z )}{ϕ ( {z}^{- 1} ) α ( z )}\end{matrix} ] \frac{1}{z}\end{matrix} ] .$$

By defining the following equation:

$$\frac{γ ( {z}^{- 1} ) ω ( z )}{ϕ ( {z}^{- 1} ) α ( z )} = \frac{β ( {z}^{- 1} )}{ϕ ( {z}^{- 1} )} + \frac{ζ ( z )}{α ( z )} z . \qquad ( 8 )$$

we can write the performance index as

$$\begin{matrix}{σ}^{2} = {Residue}_{z = 0} [ \begin{matrix}\begin{matrix}ψ ( z ) ψ ( {z}^{- 1} ) \frac{1}{z} + \\ λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} +\end{matrix} \\ [ \begin{matrix}\frac{α ( z ) l ( z )}{δ ( z ) {( 1 - z )}^{d}} - \\ \frac{β ( z )}{ϕ ( z )} - \frac{ζ ( {z}^{- 1} )}{α ( {z}^{- 1} )} {z}^{- 1}\end{matrix} ] [ \begin{matrix}\frac{α ( {z}^{- 1} ) l ( {z}^{- 1} )}{δ ( {z}^{- 1} ) {( 1 - {z}^{- 1} )}^{d}} - \\ \frac{β ( {z}^{- 1} )}{ϕ ( {z}^{- 1} )} - \\ \frac{ζ ( z )}{α ( z )} z\end{matrix} ] \frac{1}{z}\end{matrix} ] , \\ = {Residue}_{z = 0} [ \begin{matrix}ψ ( z ) ψ ( {z}^{- 1} ) \frac{1}{z} + \\ λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ \frac{ζ ( z ) ζ ( {z}^{- 1} )}{z α ( z ) α ( {z}^{- 1} )} + \\ [ \begin{matrix}\frac{α ( z ) l ( z )}{δ ( z ) {( 1 - z )}^{d}} - \\ \frac{β ( z )}{ϕ ( z )}\end{matrix} ] [ \begin{matrix}\frac{α ( {z}^{- 1} ) l ( {z}^{- 1} )}{δ ( {z}^{- 1} ) {( 1 - {z}^{- 1} )}^{d}} - \\ \frac{β ( {z}^{- 1} )}{ϕ ( {z}^{- 1} )}\end{matrix} ] \frac{1}{z}\end{matrix} ] .\end{matrix}$$

From the above equation, we can obtain the 1-DOF controller as below

$$l ( {z}^{- 1} ) = \frac{{( 1 - {z}^{- 1} )}^{d} u ( {z}^{- 1} )}{r ( {z}^{- 1} )} = \frac{δ ( {z}^{- 1} ) β ( {z}^{- 1} )}{α ( {z}^{- 1} ) {ϕ}^{*} ( {z}^{- 1} )} .$$

The controller gives the following optimal performance index value

$${\hat{σ}}_{1 - DOF}^{2} = {Residue}_{z = 0} [ \begin{matrix}ψ ( z ) ψ ( {z}^{- 1} ) \frac{1}{z} + \\ λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ \frac{ζ ( z ) ζ ( {z}^{- 1} )}{z α ( z ) α ( {z}^{- 1} )}\end{matrix} ] . \qquad ( 9 )$$

To be able to verify the derivation of the controller and to confirm the model of the control system, we must be able to calculate the sums of squares of the input and error variables as we have done in the case of the minimum prototype controller. The normalized sum of squares of the input variable (1−z⁻¹)^{d}uₜ values for the 1-DOF controller can be obtained from the equation of the controller as follows:

$${σ}_{u , 1 - DOF}^{2} = {Residue}_{z = 0} \frac{δ ( z ) β ( z ) δ ( {z}^{- 1} ) β ( {z}^{- 1} )}{z α ( z ) {ϕ}^{*} ( z ) α ( {z}^{- 1} ) {ϕ}^{*} ( {z}^{- 1} )} . \qquad ( 10 )$$

To obtain the sum of squares of the error variable, we have to obtain the equation for the error variable first. Doing this, we obtain

$$\begin{matrix}\frac{y ( {z}^{- 1} )}{r ( {z}^{- 1} )} = - \frac{ω ( {z}^{- 1} ) {z}^{- f - 1}}{δ ( {z}^{- 1} ) {( 1 - {z}^{- 1} )}^{d}} l ( {z}^{- 1} ) + \frac{θ ( {z}^{- 1} )}{ϕ ( {z}^{- 1} )} , \\ = - \frac{ω ( {z}^{- 1} ) {z}^{- f - 1}}{δ ( {z}^{- 1} )} \frac{δ ( {z}^{- 1} ) β ( {z}^{- 1} )}{α ( {z}^{- 1} ) ϕ ( {z}^{- 1} )} + \frac{θ ( {z}^{- 1} )}{ϕ ( {z}^{- 1} )} , \\ = \frac{α ( {z}^{- 1} ) θ ( {z}^{- 1} ) - ω ( {z}^{- 1} ) β ( {z}^{- 1} ) {z}^{- f - 1}}{α ( {z}^{- 1} ) ϕ ( {z}^{- 1} )} .\end{matrix}$$

If the polynomial φ(z⁻¹) has zeros of integration value, i.e. φ(z⁻¹) is not the same as φ*(z⁻¹) and d in (1−z⁻¹)^{d} is not zero, the error variable yₜ might not converge to zero because of this factor in the denominator of the above equation. However, in this case the numerator of the above equation must have a factor of (1−z⁻¹)^{d} to cancel out this factor in the denominator of the above equation. In the following discussion, we will prove this fact.

The numerator of the above equation can be written as below

$$\begin{matrix}\begin{matrix}α ( {z}^{- 1} ) θ ( {z}^{- 1} ) - \\ ω ( {z}^{- 1} ) β ( {z}^{- 1} ) {z}^{- f - 1}\end{matrix} = α ( {z}^{- 1} ) [ \begin{matrix}ψ ( {z}^{- 1} ) {ϕ}^{*} ( {z}^{- 1} ) {( 1 - {z}^{- 1} )}^{d} + \\ γ ( {z}^{- 1} ) {z}^{- f - 1}\end{matrix} ] - \\ ω ( {z}^{- 1} ) β ( {z}^{- 1} ) {z}^{- f - 1} , \\ = α ( {z}^{- 1} ) ψ ( {z}^{- 1} ) {ϕ}^{*} ( {z}^{- 1} ) {( 1 - {z}^{- 1} )}^{d} + \\ [ α ( {z}^{- 1} ) γ ( {z}^{- 1} ) - ω ( {z}^{- 1} ) β ( {z}^{- 1} ) ] {z}^{- f - 1} .\end{matrix}$$

To prove this fact we will seek the factor of (1−z⁻¹)^{d} in the second term in the square brackets on the right hand side of the above equation. From the above discussion, we can write
γ(z⁻¹)w(z)=β(z⁻¹)α(z)+φ*(z⁻¹)(1−z⁻¹)^{d}ζ(z)z.

By moving the first term on the right hand side to the left hand side of the above equation and multiplying both sides by the polynomial α(z⁻¹) (z⁻¹), we have
α(z⁻¹)w(z⁻¹)[γ(z⁻¹)w(z)−β(z⁻¹)α(z)]=φ*(z⁻¹)^{d}α(z⁻¹)w(z⁻¹)ζ(z)z
or
α(z⁻¹)γ(z⁻¹)w(z)w(z⁻¹)−w(z⁻¹)β(z⁻¹)α(z)α(z⁻¹)=φ*(z⁻¹)(1−z⁻¹)^{d}α(z⁻¹)w(z⁻¹)ζ(z)z.

By using the spectral factorization equation above, we can write the following equation:
[α(z⁻¹)γ(z⁻¹)−w(z⁻¹)β(z⁻¹)]w(z)w(z⁻¹)=λw(w⁻¹)β(z⁻¹)δ(z)(1−z)^{d}δ(z⁻¹)(1−z⁻¹)^{d}+φ*(z⁻¹)(1−z⁻¹)^{d}α(z⁻¹)w(z⁻¹)ζ(z)z.

The right hand side of the above equation has the factor (1−z⁻¹)^{d}, so the left hand side must also have this factor. This can only come from the terms inside the square brackets which is what we set out to prove.

From the above discussion, we can write

$$\begin{matrix}\frac{y ( {z}^{- 1} )}{r ( {z}^{- 1} )} = \frac{α ( {z}^{- 1} ) θ ( {z}^{- 1} ) - ω ( {z}^{- 1} ) β ( {z}^{- 1} ) {z}^{- f - 1}}{α ( {z}^{- 1} ) ϕ ( {z}^{- 1} )} , \\ = \frac{η ( {z}^{- 1} ) {( 1 - {z}^{- 1} )}^{d}}{α ( {z}^{- 1} ) {ϕ}^{*} ( {z}^{- 1} ) {( 1 - {z}^{- 1} )}^{d}} , \\ = \frac{η ( {z}^{- 1} )}{α ( {z}^{- 1} ) {ϕ}^{*} ( {z}^{- 1} )} .\end{matrix}$$

Therefore, we can calculate the normalized sum of squares of the error variable values for the 1-DOF controller as follows:

$${σ}_{y , 1 - DOF}^{2} = {Residue}_{z = 0} \frac{η ( z ) η ( {z}^{- 1} )}{z α ( z ) {ϕ}^{*} ( z ) α ( {z}^{- 1} ) {ϕ}^{*} ( {z}^{- 1} )} . \qquad ( 11 )$$

The 1-DOF controller in terms of the input and error variables is given as follows:

$${u}_{t} = \frac{δ ( {z}^{- 1} ) β ( {z}^{- 1} )}{α ( {z}^{- 1} ) θ ( {z}^{- 1} ) - ω ( {z}^{- 1} ) β ( {z}^{- 1} ) {z}^{- f - 1}} {y}_{t} . \qquad ( 12 )$$

The 2.5-DOF Linear Quadratic Tracking Controller

For the 2.5-DOF linear quadratic controller, we have a nonzero penalty constant λ in the performance index like the 1-DOF controller. However, the controller is no longer a linear combination of only past reference variable rₜ values but a linear combination of both past and future reference variable rₜ values. That means we have

$$\begin{matrix}{( 1 - {z}^{- 1} )}^{d} u ( {z}^{- 1} ) = [ {l}_{1} ( {z}^{- 1} ) + {l}_{2} ( z ) z ] r ( {z}^{- 1} ) , \\ = l ( {z}^{- 1} , z ) r ( {z}^{- 1} ) .\end{matrix}$$

Therefore, for this case the performance index can be written as

$${σ}^{2} = {Residue}_{z = 0} [ \frac{y ( z ) y ( {z}^{- 1} )}{r ( z ) r ( {z}^{- 1} )} + λ l ( z , {z}^{- 1} ) l ( {z}^{- 1} , z ) ] \frac{1}{z} .$$

With the performance index obtained, now we can proceed to derive the controller equation for this case. We have

$${σ}^{2} = {Residue}_{z = 0} [ ψ ( z ) - \frac{\begin{matrix}ω ( z ) {ϕ}^{*} ( z ) l ( z ) - \\ δ ( z ) γ ( z )\end{matrix}}{δ ( z ) ϕ ( z )} {z}^{f + 1} ] \\ [ ψ ( {z}^{- 1} ) - \frac{\begin{matrix}ω ( {z}^{- 1} ) {ϕ}^{*} ( {z}^{- 1} ) l ( {z}^{- 1} ) - \\ δ ( {z}^{- 1} ) γ ( {z}^{- 1} )\end{matrix}}{δ ( {z}^{- 1} ) ϕ ( {z}^{- 1} )} {z}^{- f - 1} ] \frac{1}{z} + {Residue}_{z = 0} λ l ( z , {z}^{- 1} ) l ( {z}^{- 1} , z ) \frac{1}{z} .$$

Like the previous case, we can write the performance index as below

$${σ}^{2} = {Residue}_{z = 0} [ ψ ( z ) ψ ( {z}^{- 1} ) \frac{1}{z} + [ \frac{ω ( z ) {ϕ}^{*} ( z ) l ( z , {z}^{- 1} ) - δ ( z ) γ ( z )}{δ ( z ) ϕ ( z )} ] \\ [ \frac{ω ( {z}^{- 1} ) {ϕ}^{*} ( {z}^{- 1} ) l ( {z}^{- 1} , z ) - δ ( {z}^{- 1} ) γ ( {z}^{- 1} )}{δ ( {z}^{- 1} ) ϕ ( {z}^{- 1} )} ] \frac{1}{z} + λ \frac{l ( z , {z}^{- 1} ) δ ( z ) {ϕ}^{*} ( z ) {( 1 - z )}^{d} δ ( {z}^{- 1} ) {ϕ}^{*} ( {z}^{- 1} ) {( 1 - {z}^{- 1} )}^{d} l ( {z}^{- 1} , z )}{z δ ( z ) ϕ ( z ) δ ( {z}^{- 1} ) ϕ ( {z}^{- 1} )} ] .$$

And by reasoning as above we can arrive at the following equation:

$${σ}^{2} = {Residue}_{z = 0} [ \begin{matrix}ψ ( z ) ψ ( {z}^{- 1} ) \frac{1}{z} + \\ λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ [ \begin{matrix}\frac{α ( z ) l ( z , {z}^{- 1} )}{δ ( z ) {( 1 - z )}^{d}} - \\ \frac{γ ( z ) ω ( {z}^{- 1} )}{ϕ ( z ) α ( {z}^{- 1} )}\end{matrix} ] [ \begin{matrix}\frac{α ( {z}^{- 1} ) l ( {z}^{- 1} , z )}{δ ( {z}^{- 1} ) {( 1 - {z}^{- 1} )}^{d}} - \\ \frac{γ ( {z}^{- 1} ) ω ( z )}{ϕ ( {z}^{- 1} ) α ( z )}\end{matrix} ] \frac{1}{z}\end{matrix} ] .$$

The performance index σ² can be minimized by setting

$$\frac{α ( {z}^{- 1} )}{δ ( {z}^{- 1} ) {( 1 - {z}^{- 1} )}^{d}} l ( {z}^{- 1} , z ) = \frac{γ ( {z}^{- 1} ) ω ( z )}{ϕ ( {z}^{- 1} ) α ( z )} .$$

The above equation gives us the controller in one form. To obtain the controller in an implementable form, we write

$$\frac{α ( {z}^{- 1} )}{δ ( {z}^{- 1} ) {( 1 - {z}^{- 1} )}^{d}} \frac{{( 1 - {z}^{- 1} )}^{d} u ( {z}^{- 1} )}{r ( {z}^{- 1} )} = \frac{γ ( {z}^{- 1} ) ω ( z )}{ϕ ( {z}^{- 1} ) α ( z )} , \\ \frac{α ( {z}^{- 1} ) u ( {z}^{- 1} )}{δ ( {z}^{- 1} ) r ( {z}^{- 1} )} = \frac{β ( {z}^{- 1} )}{ϕ ( {z}^{- 1} )} + \frac{ζ ( z )}{α ( z )} z , \\ \frac{α ( {z}^{- 1} ) θ ( {z}^{- 1} ) u ( {z}^{- 1} )}{δ ( {z}^{- 1} ) ϕ ( {z}^{- 1} ) {y}^{sp} ( {z}^{- 1} )} = \frac{β ( {z}^{- 1} )}{ϕ ( {z}^{- 1} )} + \frac{ζ ( z )}{α ( z )} z .$$

In terms of the variables in the time domain, we can write

$$\begin{matrix}\frac{α ( {z}^{- 1} )}{δ ( {z}^{- 1} )} \frac{θ ( {z}^{- 1} )}{ϕ ( {z}^{- 1} )} {u}_{t} = \frac{β ( {z}^{- 1} )}{ϕ ( {z}^{- 1} )} {y}_{t}^{sp} + \frac{ζ ( z )}{α ( z )} {zy}_{t}^{sp} , \\ = \frac{β ( {z}^{- 1} )}{ϕ ( {z}^{- 1} )} {y}_{t}^{sp} + {υ}_{t} .\end{matrix}$$

The variable vₜ is a converging sum of the weighted future set point values. From the above equation, we can derive the equation for the controller as follows.

$$\begin{matrix}\frac{α ( {z}^{- 1} )}{δ ( {z}^{- 1} )} \frac{θ ( {z}^{- 1} )}{ϕ ( {z}^{- 1} )} {u}_{t} = \frac{β ( {z}^{- 1} )}{ϕ ( {z}^{- 1} )} {y}_{t}^{sp} + {υ}_{t} , \\ = \frac{β ( {z}^{- 1} )}{ϕ ( {z}^{- 1} )} [ {\hat{y}}_{t} + {y}_{t} ] + {υ}_{t} , \\ = \frac{β ( {z}^{- 1} )}{ϕ ( {z}^{- 1} )} [ \frac{ω ( {z}^{- 1} )}{δ ( {z}^{- 1} )} {z}^{- f - 1} {u}_{t} + {y}_{t} ] + {υ}_{t} .\end{matrix}$$

By moving the term with the input variable from the right hand side of the above equation to its left hand side, we can write

$$[ \frac{α ( {z}^{- 1} )}{δ ( {z}^{- 1} )} \frac{θ ( {z}^{- 1} )}{ϕ ( {z}^{- 1} )} - \frac{β ( {z}^{- 1} )}{ϕ ( {z}^{- 1} )} \frac{ω ( {z}^{- 1} )}{δ ( {z}^{- 1} )} {z}^{- f - 1} ] {u}_{t} = \frac{β ( {z}^{- 1} )}{ϕ ( {z}^{- 1} )} {y}_{t} + {v}_{t} .$$

And therefore, we can obtain the controller as below

$${u}_{t} = \frac{δ ( {z}^{- 1} ) β ( {z}^{- 1} )}{α ( {z}^{- 1} ) θ ( {z}^{- 1} ) - ω ( {z}^{- 1} ) β ( {z}^{- 1} ) {z}^{- f - 1}} {y}_{t} + \frac{δ ( {z}^{- 1} ) ϕ ( {z}^{- 1} )}{α ( {z}^{- 1} ) θ ( {z}^{- 1} ) - ω ( {z}^{- 1} ) β ( {z}^{- 1} ) {z}^{- f - 1}} {v}_{t} . \qquad ( 13 )$$

The normalized sum of squares of the input variable (1−z⁻¹)^{d}uₜ values for the 2.5-DOF controller can be calculated as follows:

$${σ}_{u , 2.5 - DOF}^{2} = {Residue}_{z = 0} \frac{δ ( z ) γ ( z ) ω ( z ) δ ( {z}^{- 1} ) γ ( {z}^{- 1} ) ω ( {z}^{- 1} )}{z {ϕ}^{*} ( z ) α ( z ) α ( z ) {ϕ}^{*} ( {z}^{- 1} ) α ( {z}^{- 1} ) α ( {z}^{- 1} )} . \qquad ( 14 )$$

The optimal performance index for this controller is given below

$${σ}_{2.5 - DOF}^{2} = {Residue}_{z = 0} [ ψ ( z ) ψ ( {z}^{- 1} ) \frac{1}{2} + λ \frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} ] . \qquad ( 15 )$$

To calculate the normalized sum of squares of the error variable values for the 2.5-DOF controller, we need to obtain the expression for the output variable first. This can be obtained as follows.

$$\begin{matrix}\frac{\hat{y} ( {z}^{- 1} )}{r ( {z}^{- 1} )} = \frac{ω ( {z}^{- 1} )}{δ ( {z}^{- 1} )} \frac{u ( {z}^{- 1} )}{r ( {z}^{- 1} )} {z}^{- f - 1} , \\ = \frac{ω ( {z}^{- 1} )}{δ ( {z}^{- 1} )} [ \frac{δ ( {z}^{- 1} ) γ ( {z}^{- 1} ) ω ( z )}{α ( {z}^{- 1} ) ϕ ( {z}^{- 1} ) α ( z )} ] {z}^{- f - 1} , \\ = \frac{γ ( {z}^{- 1} ) ω ( {z}^{- 1} ) ω ( z )}{ϕ ( {z}^{- 1} ) α ( {z}^{- 1} ) α ( z )} {z}^{- f - 1} .\end{matrix}$$

The existence of the polynomial w(z) along the side of the polynomial w(z⁻¹) is an indication that the 2.5-DOF controller can suppress the inverse response of a nonminimum phase system.

From the above equation, we can write the error variable as below

$$\begin{matrix}\frac{y ( {z}^{- 1} )}{r ( {z}^{- 1} )} = \frac{θ ( {z}^{- 1} )}{ϕ ( {z}^{- 1} )} - \frac{γ ( {z}^{- 1} ) ω ( {z}^{- 1} ) ω ( z )}{ϕ ( {z}^{- 1} ) α ( {z}^{- 1} ) α ( z )} {z}^{- f - 1} , \\ = ψ ( {z}^{- 1} ) + \frac{γ ( {z}^{- 1} ) [ α ( {z}^{- 1} ) α ( z ) - ω ( {z}^{- 1} ) ω ( z ) ]}{ϕ ( {z}^{- 1} ) α ( {z}^{- 1} ) α ( z )} {z}^{- f - 1} , \\ ψ ( {z}^{- 1} ) + λ \frac{γ ( {z}^{- 1} ) [ {( 1 - {z}^{- 1} )}^{d} δ ( {z}^{- 1} ) {( 1 - z )}^{d} δ ( z ) ]}{ϕ ( {z}^{- 1} ) α ( {z}^{- 1} ) α ( z )} {z}^{- f - 1} , \\ = ψ ( {z}^{- 1} ) + λ \frac{γ ( {z}^{- 1} ) δ ( {z}^{- 1} ) {( 1 - z )}^{d} δ ( z )}{{ϕ}^{*} ( {z}^{- 1} ) α ( {z}^{- 1} ) α ( z )} {z}^{- f - 1} .\end{matrix}$$

From this equation, we can calculate the normalized sum of squares of the error variable values for the 2.5-DOF controller from the following equation:

$${σ}_{y , 2.5 - DOF}^{2} = {Residue}_{z = 0} [ ψ ( z ) ψ ( {z}^{- 1} ) \frac{1}{z} + {λ}^{2} \frac{γ ( z ) δ ( z ) δ ( z ) {( 1 - z )}^{d} γ ( {z}^{- 1} ) δ ( {z}^{- 1} ) δ ( {z}^{- 1} ) {( 1 - {z}^{- 1} )}^{d}}{z {ϕ}^{*} ( z ) α ( z ) α ( z ) {ϕ}^{*} ( {z}^{- 1} ) α ( {z}^{- 1} ) α ( {z}^{- 1} )} ] . \qquad ( 16 )$$

From the optimal value of the performance index, we can say that the controllers differ only in the case of constrained control. If the penalty constant λ=0, the controllers are the same and there will be no feedforward path in the 2.5-DOF controller. In this case, both controllers are the same as the minimal prototype dead beat controller.

The Regulating Control System

A regulating control system can be depicted in FIG. 2. The model for the stochastic regulating control system is the Box-Jenkins model stochastic control model:

$$\begin{matrix}{y}_{t} = \frac{ω ( {z}^{- 1} )}{δ ( {z}^{- 1} )} {u}_{t - f - 1} + \frac{θ ( {z}^{- 1} )}{{( 1 - {z}^{- 1} )}^{d} {ϕ}^{*} ( {z}^{- 1} )} {a}_{t} , \\ = \frac{ω ( {z}^{- 1} )}{δ ( {z}^{- 1} )} {u}_{t - f - 1} + ψ ( {z}^{- 1} ) {a}_{t} + \frac{γ ( {z}^{- 1} )}{{( 1 - {z}^{- 1} )}^{d} {ϕ}^{*} ( {z}^{- 1} )} {a}_{t - f - 1} .\end{matrix}$$

The performance index for the controller is the variance of the output variable yₜ and a weighted variance of the input variable ∇^{d}uₜ, i.e. we have
\hat{σ}²=Min σ_{y}²+λσ_{∇}²_{d}_{ᵤ}.

And the stochastic regulating controller for this performance index can be obtained as follows.

Now let us say that we have the controller l(z⁻¹) as below
∇^{d}uₜl(z⁻¹)aₜ.

Since we have the control model of the system as

$${y}_{t + f + 1} = \frac{ω ( {z}^{- 1} )}{δ ( {z}^{- 1} )} {u}_{t} + ψ ( {z}^{- 1} ) {a}_{t + f + 1} + \frac{γ ( {z}^{- 1} )}{ϕ ( {z}^{- 1} )} {a}_{t} ,$$

we can write the output variable under feedback as

$${y}_{t + f + 1} = [ \frac{ω ( {z}^{- 1} ) {ϕ}^{*} ( {z}^{- 1} ) l ( {z}^{- 1} ) + γ ( {z}^{- 1} ) δ ( {z}^{- 1} )}{δ ( {z}^{- 1} ) ϕ ( {z}^{- 1} )} ] {a}_{t} + ψ ( {z}^{- 1} ) {a}_{t + f + 1} .$$

Using the spectral formula for the variance, we can write the variance of the output variable as below

$${σ}_{y}^{2} = {σ}_{a}^{2} {Residue}_{z = 0} [ \frac{ψ ( z ) ψ ( {z}^{- 1} )}{z} + \frac{[ ω ( {z}^{- 1} ) ϕ * ( {z}^{- 1} ) l ( {z}^{- 1} ) + γ ( {z}^{- 1} ) δ ( {z}^{- 1} ) ] [ ω ( z ) ϕ * ( z ) l ( z ) + γ ( z ) δ ( z ) ]}{z δ ( {z}^{- 1} ) ϕ ( {z}^{- 1} ) δ ( z ) ϕ ( z )} ] .$$

Similarly, the variance of the differenced input variable is given as below

$${σ}_{{∇}^{d} u}^{2} = {σ}_{a}^{2} {Residue}_{z = 0} \frac{δ ( {z}^{- 1} ) {( 1 - {z}^{- 1} )}^{d} ϕ * ( {z}^{- 1} ) l ( {z}^{- 1} ) δ ( z ) {( 1 - z )}^{d} ϕ * ( z ) l ( z )}{z δ ( {z}^{- 1} ) ϕ ( {z}^{- 1} ) δ ( z ) ϕ ( z )} .$$

Then the performance index can be written as

$${σ}^{2} = {σ}_{a}^{2} {Residue}_{z = 0} [ ψ ( z ) ψ ( {z}^{- 1} ) \frac{1}{z} + [ \frac{ω ( z ) ϕ * ( z ) l ( z ) + δ ( z ) γ ( z )}{δ ( z ) ϕ ( z )} ] [ \frac{ω ( {z}^{- 1} ) ϕ * ( {z}^{- 1} ) l ( {z}^{- 1} ) + δ ( {z}^{- 1} ) γ ( {z}^{- 1} )}{δ ( {z}^{- 1} ) ϕ ( {z}^{- 1} )} ] \frac{1}{z} + λ \frac{l ( z ) δ ( z ) ϕ * ( z ) {( 1 - z )}^{d} δ ( {z}^{- 1} ) ϕ * ( {z}^{- 1} ) {( 1 - {z}^{- 1} )}^{d} l ( {z}^{- 1} )}{z δ ( z ) ϕ ( z ) δ ( {z}^{- 1} ) ϕ ( {z}^{- 1} )} ] .$$

Comparing the above equation to the equation of the performance index of the 1-DOF controller, we can say as follows. The spectral factorization equation will be the same as the tracking control case, i.e. we have
α(z)α(z⁻¹)=w(z)w(z⁻¹)+λδ(z)(1−z)^{d}δ(z⁻¹)(1−z⁻¹)^{d}.

The spectral separation equation is also the same and is given by

$$\frac{γ ( {z}^{- 1} ) ω ( z )}{ϕ ( {z}^{- 1} ) α ( z )} = \frac{β ( {z}^{- 1} )}{ϕ ( {z}^{- 1} )} + \frac{ζ ( z )}{α ( z )} z .$$

However, the controller will be opposite in sign and is given as below

$${u}_{t} = - \frac{δ ( {z}^{- 1} ) β ( {z}^{- 1} )}{α ( {z}^{- 1} ) θ ( {z}^{- 1} ) - ω ( {z}^{- 1} ) β ( {z}^{- 1} ) {z}^{- f - 1}} {y}_{t} . \qquad ( 17 )$$

With this controller we can obtain the variance of the output variable as below

$${σ}_{y , lqg}^{2} = {Residue}_{z = 0} [ ψ ( z ) ψ ( {z}^{- 1} ) \frac{1}{z} + \frac{η ( z ) η ( {z}^{- 1} )}{z α ( z ) ϕ * ( z ) α ( {z}^{- 1} ) ϕ * ( {z}^{- 1} )} ] {σ}_{a}^{2} . \qquad ( 18 )$$

where σₐ² is the variance of the white noise at and the polynomial η(z⁻¹) is given below

$$η ( {z}^{- 1} ) = \frac{α ( {z}^{- 1} ) γ ( {z}^{- 1} ) - ω ( {z}^{- 1} ) β ( {z}^{- 1} )}{{( 1 - {z}^{- 1} )}^{d}} .$$

The variance of the input variable will become

$${σ}_{u , lqg}^{2} = {Residue}_{z = 0} \frac{δ ( z ) β ( z ) δ ( {z}^{- 1} ) β ( {z}^{- 1} )}{z α ( z ) ϕ * ( z ) α ( {z}^{- 1} ) ϕ * ( {z}^{- 1} )} {σ}_{a}^{2} . \qquad ( 19 )$$

And the controller gives the following optimal performance index value:

$${σ}_{lqg}^{2} = {Residue}_{z = 0} [ ψ ( z ) ψ ( {z}^{- 1} ) \frac{1}{z} + λ \frac{δ ( z ) γ ( z ) δ ( {z}^{- 1} ) γ ( {z}^{- 1} )}{z α ( z ) ϕ * ( z ) α ( {z}^{- 1} ) ϕ * ( {z}^{- 1} )} + \frac{ζ ( z ) ζ ( {z}^{- 1} )}{z α ( z ) α ( {z}^{- 1} )} ] {σ}_{a}^{2} . \qquad ( 20 )$$

Methods of Implementation

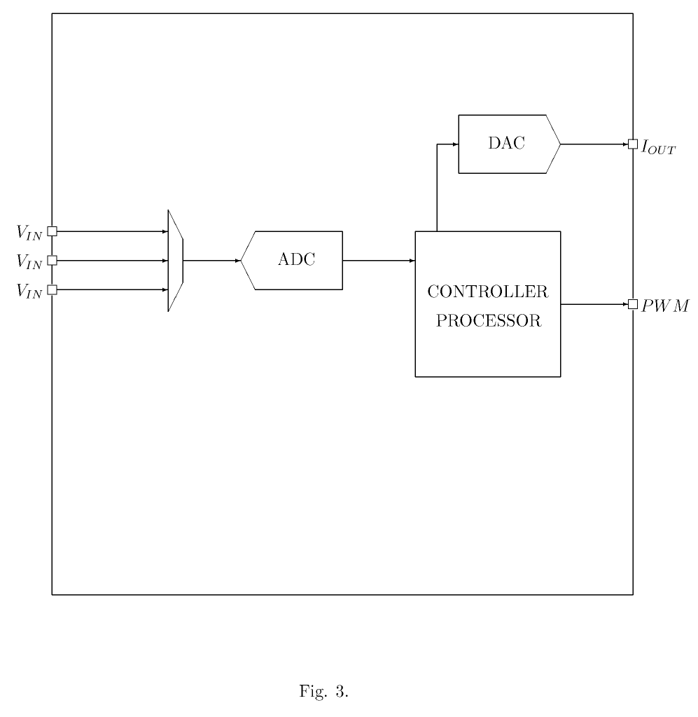

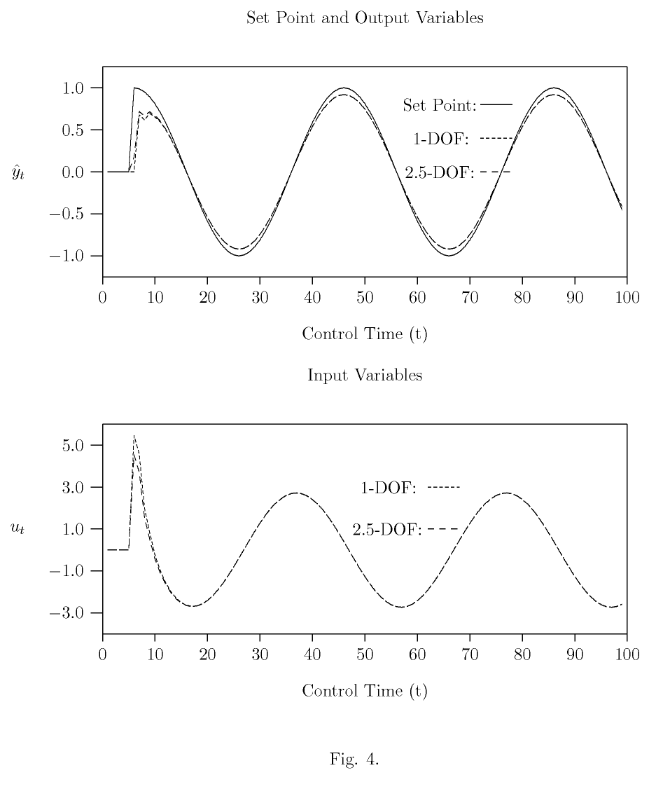

The controllers discussed above can be implemented in a number of ways depending on the application. For plant or big machine control, implementation can be done with computing devices like a personal computer. But for small environment control applications like in a hand-held electronic gadget, a special digital chip can be the method of implementation. In either case, implementation can be done with a single System-On-a-Chip (SOC) chip. On this chip, the controller's parameters and the execution program can reside in the Read-Only-Memory of the chip. The variables must be in the Random-Access-Memory. The variable to be controlled must be fed through an Analog-Digital-Converter for discretization. However, the control variable can be outputted in either analog or discrete form. The set point variable can be generated internally. The configuration of the chip is depicted in FIG. 3.

### SOME EXAMPLES

Now we will consider some examples of these two tracking controllers. In the first example, we assume that we have a control system with the following transfer function:

$${G}_{p} ( {z}^{- 1} ) = \frac{0.1242 - 0.0422 {z}^{- 1}}{1 - 0.4118 {z}^{- 1} - 0.5677 {z}^{- 2}} {z}^{- 1} .$$

The control system is supposed to track a cosine wave form with the following equation:

$${y}_{t}^{sp} = cos \frac{π}{20} t .$$

With these information given we can find and compare the performances of the 1-DOF and the 2.5-DOF controllers. Since the difference exists only in the case of constrained control, we assume that the penalty constant is λ=0.01.

The z transform of the cosine wave is

$$\begin{matrix}ℨ cos \frac{π}{20} t = \frac{{z}^{2} - cos ( π / 20 ) z}{{z}^{2} - 2 cos ( π / 20 ) z + 1} , \\ = \frac{{z}^{2} - 0.98769 z}{{z}^{2} - 1.97538 z + 1} , \\ = \frac{1 - 0.98769 {z}^{- 1}}{1 - 1.97538 {z}^{- 1} + {z}^{- 2}} .\end{matrix}$$

Therefore, we have the model of the set point variable as below

$$\begin{matrix} \frac{θ ( {z}^{- 1} )}{ϕ ( {z}^{- 1} )} = ψ ( {z}^{- 1} ) + \frac{γ ( {z}^{- 1} )}{ϕ ( {z}^{- 1} )} {z}^{- 1} , \\ = 1 + \frac{0.98769 - {z}^{- 1}}{1 - 1.97538 {z}^{- 1} + {z}^{- 2}} {z}^{- 1} .\end{matrix}$$

With the model of the set point variable obtained, now we have to obtain the polynomial α(z⁻¹) from the spectral factorization equation

$$\begin{matrix}α ( z ) α ( {z}^{- 1} ) = ω ( z ) ω ( {z}^{- 1} ) + λ δ ( z ) δ ( {z}^{- 1} ) , \\ = ( 0.1242 - 0.0422 z ) ( 0.1242 - 0.0422 {z}^{- 1} ) + \\ 0.01 ( 1 - 0.4118 {z}^{1} - 0.5677 {z}^{2} ) \\ ( 1 - 0.4118 {z}^{- 1} - 0.5677 {z}^{- 2} ) .\end{matrix}$$

The solution for the polynomial a(z⁻¹) is
α(z⁻¹)=0.1681−0.0523z⁻¹−0.0338z⁻².

The spectral separation equation for the 1-DOF controller can be obtained as below

$$\begin{matrix}\frac{γ ( {z}^{- 1} ) ω ( z )}{ϕ ( {z}^{- 1} ) α ( z )} = \frac{( 0.98769 - {z}^{- 1} ) ( 0.1242 - 0.0422 z )}{( 1 - 1.97538 {z}^{- 1} + {z}^{- 2} ) ( 0.1681 - 0.0523 z - 0.0338 {z}^{2} )} , \\ = \frac{0.9174 - 0.9496 {z}^{- 1}}{1 - 1.97538 {z}^{- 1} + {z}^{- 2}} + \\ \frac{0.0354 + 0.0310 z}{0.1681 - 0.0523 {z}^{1} - 0.0338 {z}^{2}} z , \\ = \frac{β ( {z}^{- 1} )}{ϕ ( {z}^{- 1} )} + \frac{ζ ( z )}{α ( z )} z .\end{matrix}$$

Therefore, the controller for this case is

$$\begin{matrix}{G}_{c} ( {z}^{- 1} ) = \frac{δ ( {z}^{- 1} ) β ( {z}^{- 1} )}{α ( {z}^{- 1} ) θ ( {z}^{- 1} ) - ω ( {z}^{- 1} ) β ( {z}^{- 1} ) {z}^{- 1}} , \\ = \frac{5.4580 - 7.8974 {z}^{- 1} - 0.7719 {z}^{- 2} + 3.2074 {z}^{- 3}}{1 - 1.9766 {z}^{- 1} + 1.0383 {z}^{- 2} - 0.0399 {z}^{- 3}} .\end{matrix}$$

The feedback path does not have integral action, because the polynomial φ(z⁻¹) does not have a zero of integration value, i.e. z⁻¹=1. With the above data, we can obtain the equation for the 2.5-DOF controller as below

$$\begin{matrix}{u}_{t} = \frac{δ ( {z}^{- 1} ) β ( {z}^{- 1} )}{α ( {z}^{- 1} ) θ ( {z}^{- 1} ) = ω ( {z}^{- 1} ) β ( {z}^{- 1} ) {z}^{- 1}} {y}_{t} + \\ \frac{δ ( {z}^{- 1} ) ϕ ( {z}^{- 1} )}{α ( {z}^{- 1} ) θ ( {z}^{- 1} ) - ω ( {z}^{- 1} ) β ( {z}^{- 1} ) {z}^{- 1}} {v}_{t} , \\ = \frac{5.4580 - 7.8974 {z}^{- 1} - 0.7719 {z}^{- 2} + 3.2074 {z}^{- 3}}{1 - 1.9766 {z}^{- 1} + 1.0383 {z}^{- 2} - 0.0399 {z}^{- 3}} {y}_{t} + \\ \frac{5.9459 - 14.2026 {z}^{- 1} + 7.4117 {z}^{- 2} + 4.2219 {z}^{- 3} - 3.3775 {z}^{- 4}}{1 - 1.9766 {z}^{- 1} + 1.0383 {z}^{- 2} - 0.0399 {z}^{- 3}} {v}_{t} .\end{matrix}$$

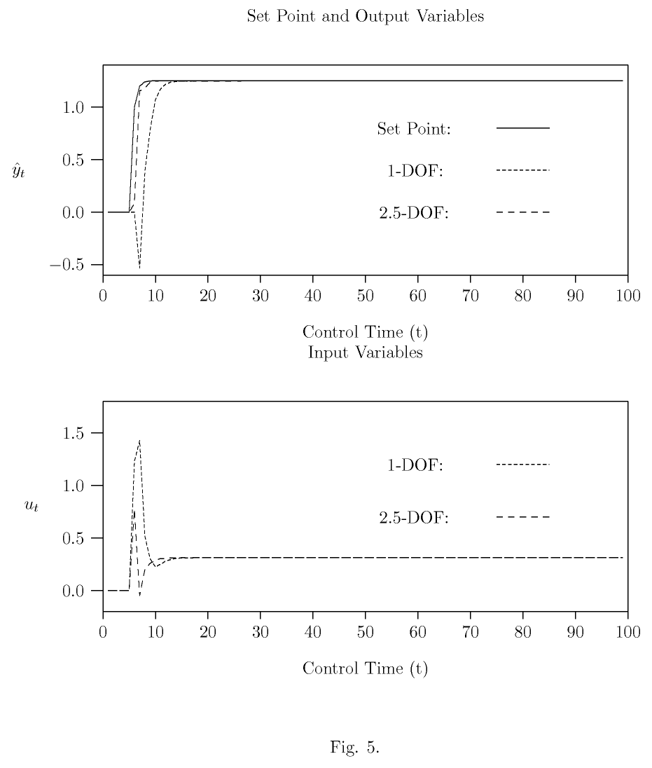

The performances of the two controllers are depicted in FIG. 4. In this case the performances are close, but we can still notice an improvement of the 2.5-DOF controller. Improvement can be quite substantial when the control system is nonminimum phase as the next example and FIG. 5 will show.

In the second example, we consider the following nonminimum phase control system:

$${\hat{y}}_{t} = \frac{- 0.4322 + 0.7806 {z}^{- 1} + 0.4655 {z}^{- 2} - 0.1942 {z}^{- 3}}{1 + 0.0835 {z}^{- 1} - 1.2126 {z}^{- 2} - 0.0635 {z}^{- 3} + 0.3475 {z}^{- 4}} {u}_{t - 1} .$$

The system is demanded to follow an exponential change to a new set point with the equation

$$\frac{θ ( {z}^{- 1} )}{ϕ ( {z}^{- 1} )} = \frac{1}{( 1 - 0.2 {z}^{- 1} ) ( 1 - {z}^{- 1} )} .$$

The system is nonminimum phase and so a penalty constant is imperative for the system. Assuming that the penalty constant has a value of λ=0.05, we can obtain the following polynomials:
α(z⁻¹)=1.0272−0.073z⁻¹−0.4736z⁻²+0.1363z⁻³+0.0341z⁻¹−0.0169z⁻⁵,
β(z⁻¹)=1.2631−0.2631z⁻¹,
ζ(z⁻¹)=1.7833′0.7238z⁻¹−0.4267z⁻²−0.0218z⁻³+0.0214z⁻⁴.

With all the necessary polynomials procured, we can get the 2.5-DOF controller as below

$${U}_{t} = \frac{\begin{matrix}1.2297 - 0.1534 {z}^{- 1} - 1.5125 {z}^{- 2} + \\ 0.2325 {z}^{- 3} + 0.4436 {z}^{- 4} - 0.0890 {z}^{- 5}\end{matrix}}{\begin{matrix}1 + 0.4465 {z}^{- 1} - 1.5317 {z}^{- 2} - \\ 0.2398 {z}^{- 3} + 0.3912 {z}^{- 4} - 0.0662 {z}^{- 5}\end{matrix}} {y}_{t} + \frac{\begin{matrix}0.9736 - 1.087 {z}^{- 1} - 1.0834 {z}^{- 2} + 1.3711 {z}^{- 3} + \\ 0.1764 {z}^{- 4} - 0.4183 {z}^{- 5} + 0.0677 {z}^{- 6}\end{matrix}}{\begin{matrix}1 + 0.4465 {z}^{- 1} - 1.5317 {z}^{- 2} - 0.2398 {z}^{- 3} + \\ 0.3912 {z}^{- 4} - 0.0662 {z}^{- 5}\end{matrix}} {v}_{t} .$$

The 1-DOF controller will be given by the first term of the above equation. The controller has integral action in the feedback loop, because the denominator polynomials in the above equation has a zero of z⁻¹=1. However, the feedforward path does not have integral action, because this zero of integration is canceled out by a zero of the same value. The responses of the variables from the two controllers are shown in FIG. 5. From the top graph of this figure, we can see that the 1-DOF controller cannot overcome an inverse response by a change of the set point to a new level but the 2.5-DOF controller can.

Now we will check the value of the performance indices of the controllers. For the 1-DOF controller, we have

$$\begin{matrix}{σ}_{1 - DOF}^{2} = {Residue}_{z = 0} [ ψ ( z ) ψ ( {z}^{- 1} ) \frac{1}{z} + λ \begin{matrix}\frac{δ ( z ) γ ( z ) δ ( {z}^{- 1} ) γ ( {z}^{- 1} )}{z α ( z ) {ϕ}^{*} ( z ) α ( {z}^{- 1} ) {ϕ}^{*} ( {z}^{- 1} )} + \\ \frac{ζ ( z ) ζ ( {z}^{- 1} )}{z α ( z ) α ( {z}^{- 1} )}\end{matrix} ] , \\ = 1 + 0.05 \times 2.2030 + 3.9888 , \\ = 5.0990 , \\ = 4.9773 + 0.05 \times 2.4336 , \\ = {σ}_{y , 1 - DOF}^{2} + λ {σ}_{u , 1 - DOF}^{2} .\end{matrix}$$

For the 2.5-DOF controller, we have

$$\begin{matrix}{\hat{σ}}_{2.5 - DOF}^{2} = {Residue}_{z = 0} [ ψ ( z ) ψ ( {z}^{- 1} ) \frac{1}{z} + λ \frac{δ ( z ) γ ( z ) δ ( {z}^{- 1} ) γ ( {z}^{- 1} )}{z α ( z ) ϕ * ( z ) α ( {z}^{- 1} ) ϕ * ( {z}^{- 1} )} ] \\ = 1.1101 , \\ = 1.0201 + 0.05 \times 1.8001 , \\ = {σ}_{y , 2.5 - DOF}^{2} + λ {σ}_{u , 2.5 - DOF}^{2} .\end{matrix} ,$$

For both cases, the controllers obey their performance indices.

### CONCLUSION

This invention has presented three linear quadratic tracking controllers. These are the minimum prototype, 1-DOF and 2.5-DOF controllers. The minimum prototype is an unconstrained controller. The 1-DOF controller is a fine controller, but the 2.5-DOF controller has a stronger performance for nonminimum phase systems. This is due to the fact that it has the future set point values fed forward to the controller. The invention also presented the linear quadratic regulating controller. This controller is the stochastic counterpart of the 1-DOF controller.

TABLE 1
Table of Some Set Point Models

| $Continuous {y}_{t}^{sp}$ | | Set Point Model |
|---|---|---|
| 1 | δ(t) | θ(z⁻¹) = 1, φ(z⁻¹) = 1, r = 1 |
| 2 | δ(t − k) | θ(z⁻¹) = 0 − . . . + z^{-k}, φ(z⁻¹) = 1, r = 1 |
| 3 | unit step | θ(z⁻¹) = 1, φ(z⁻¹) = 1 − z⁻¹, r = 1 |
| 4 | t | θ(z⁻¹) = 0 − z⁻¹, φ(z⁻¹) = 1 − 2z⁻¹ + z⁻², r = 1 |
| 5 | t² | $\frac{θ ( {z}^{- 1} )}{ϕ ( {z}^{- 1} )} = \frac{0 + {z}^{- 1} + {z}^{- 2}}{{( 1 - {z}^{- 1} )}^{3}} , r = 1$ |
| 6 | ${\overbrace{t ( t - 1 ) … ( t - n + 1 )}}^{n times}$ | $\frac{θ ( {z}^{- 1} )}{ϕ ( {z}^{- 1} )} = \frac{0 - ⋯ + n ! {z}^{- n}}{{( 1 - {z}^{- 1} )}^{n + 1}} , r = 1$ |
| 7 | e^{-at} | θ(z⁻¹) = 1, φ(z⁻¹) = 1 − e^{-a} z⁻¹, r = 1 |
| 8 | 1 − e^{-at} | $\frac{θ ( {z}^{- 1} )}{ϕ ( {z}^{- 1} )} = \frac{0 + ( 1 - {e}^{- a} ) {z}^{- 1}}{( 1 - {z}^{- 1} ) ( 1 - {e}^{- a} {z}^{- 1} )} , r = 1$ |
| 9 | te^{-at} | $\frac{θ ( {z}^{- 1} )}{ϕ ( {z}^{- 1} )} = \frac{0 + {e}^{- a} {z}^{- 1}}{{( 1 - {e}^{- a} {z}^{- 1} )}^{2}} , r = 1$ |
| 10 | $\frac{1}{a} ( at - 1 + {e}^{- at} )$ | $\frac{θ ( {z}^{- 1} )}{ϕ ( {z}^{- 1} )} = \frac{0 + ( a - 1 + {e}^{- a} ) {z}^{- 1} + ( 1 - {e}^{- a} - {ae}^{- a} ) {z}^{- 2}}{{( 1 - {z}^{- 1} )}^{2} ( 1 - {e}^{- a} {z}^{- 1} )} , r = \frac{1}{a}$ |
| 11 | e^{-at} − e^{-bt} | $\frac{θ ( {z}^{- 1} )}{ϕ ( {z}^{- 1} )} = \frac{0 + ( {e}^{- a} - {e}^{- b} ) {z}^{- 1}}{( 1 - {e}^{- a} {z}^{- 1} ) ( 1 - {e}^{- b} {z}^{- 1} )} , r = 1$ |
| 12 | (1 − at)e^{-at} | $\frac{θ ( {z}^{- 1} )}{ϕ ( {z}^{- 1} )} = \frac{1 - ( 1 + a ) {e}^{- a} {z}^{- 1}}{{( 1 - {e}^{- a} {z}^{- 1} )}^{2}} , r = 1$ |
| 13 | 1 − (1 + at)e^{-at} | $\frac{θ ( {z}^{- 1} )}{ϕ ( {z}^{- 1} )} = \frac{0 + ( 1 - {e}^{- a} - {ae}^{- a} ) {z}^{- 1} + ( {e}^{- 2 a} - {e}^{- a} + {ae}^{- a} ) {z}^{- 2}}{( 1 - {z}^{- 1} ) {( 1 - {e}^{- a} {z}^{- 1} )}^{2}} , r = 1$ |
| 14 | be^{-bt} − ae^{-at} | $\frac{θ ( {z}^{- 1} )}{ϕ ( {z}^{- 1} )} = \frac{( b - a ) - ( {be}^{- a} - {ae}^{- b} ) {z}^{- 1}}{( 1 - {e}^{- a} {z}^{- 1} ) ( 1 - {e}^{- b} {z}^{- 1} )} , r = 1$ |
| 15 | sinωt | $\frac{θ ( {z}^{- 1} )}{ϕ ( {z}^{- 1} )} = \frac{0 + sin ω {z}^{- 1}}{1 - 2 cos ω {z}^{- 1} + {z}^{- 2}} , r = 1$ |
| 16 | cosωt | $\frac{θ ( {z}^{- 1} )}{ϕ ( {z}^{- 1} )} = \frac{1 - cos ω {z}^{- 1}}{1 - 2 cos ω {z}^{- 1} + {z}^{- 2}} , r = 1$ |
| 17 | sinhωt | $\frac{θ ( {z}^{- 1} )}{ϕ ( {z}^{- 1} )} = \frac{0 + sin h ω {z}^{- 1}}{1 - 2 cos h ω {z}^{- 1} + {z}^{- 2}} , r = 1$ |
| 18 | coshωt | $\frac{θ ( {z}^{- 1} )}{ϕ ( {z}^{- 1} )} = \frac{1 - cos h ω {z}^{- 1}}{1 - 2 cos h ω {z}^{- 1} + {z}^{- 2}} , r = 1$ |
| 19 | e^{-at}sinωt | $\frac{θ ( {z}^{- 1} )}{ϕ ( {z}^{- 1} )} = \frac{0 + {e}^{- a} sin ω {z}^{- 1}}{1 - 2 {e}^{- a} cos ω {z}^{- 1} + {e}^{- 2 a} {z}^{- 2}} , r = 1$ |
| 20 | e^{-at}cosωt | $\frac{θ ( {z}^{- 1} )}{ϕ ( {z}^{- 1} )} = \frac{1 - {e}^{- a} cos ω {z}^{- 1}}{1 - 2 {e}^{- a} cos ω {z}^{- 1} + {e}^{- 2 a} {z}^{- 2}} , r = 1$ |
| 21 | a^{t} | θ(z⁻¹) = 1, φ(z⁻¹) = 1 − az⁻¹, r = 1 |
| 22 | a^{t}cosπt | θ(z⁻¹) = 1, φ(z⁻¹) = 1 + az⁻¹, r = 1 |

I claim:

1. A method to generate the future set point values yₜ^{sp} for a tracking control system.

2. A method to obtain the parameters of the minimum prototype unconstrained controller for a tracking control system.

3. An on-line method to verify the design model of a tracking control system with the plant model of the physical equipment by calculating the sum of squared values of the input variable (1−z⁻¹)^{d}uₜ obtained from a measurement sensor and comparing that with the quantity σ_{u,MP}², if the tracking control system is under feedback with the minimum prototype unconstrained controller given in claim 2.

4. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ=yₜ^{sp}−ŷₜ) and comparing that with the quantity σ_{y,MP}², if the tracking control system is under feedback with the minimum prototype unconstrained controller given in claim 2.

5. A method to obtain the parameters of the 1-DOF linear quadratic controller.

6. A method to verify the 1-DOF controller of a tracking control system by comparing the performance index value of the 1-DOF controller given by the quantity \hat{σ}_{1-DOF}² and the sum of the quantities σ_{y,1-DOF}² and λσ_{u,1-DOF}².

7. An on-line method to verify the design model of a tracking control system with the plant model of the physical equipment by calculating the sum of squared values of the input variable (1−z⁻¹)^{d}uₜ obtained from a measurement sensor and comparing that with the quantity σ_{u,1-DOF}², if the tracking control system is under feedback with the 1-DOF controller given in claim 5.

8. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ=yₜ^{sp}−ŷₜ) and comparing that with the quantity σ_{y,1-DOF}², if the tracking control system is under feedback with the 1-DOF controller given in claim 5.

9. A method to obtain the parameters of the 2.5-DOF linear quadratic controller.

10. A method to verify the 2.5-DOF controller of a tracking control system by comparing the performance index value of the 2.5-DOF controller given by the quantity \hat{σ}_{2.5-DOF}² and the sum of the quantities σ_{y,2.5-DOF}² and λσ_{u,2.5-DOF}².

11. An on-line method to verify the design model of a tracking control system with the plant model of the physical equipment by calculating the sum of squared values of the input variable (1−z⁻¹)^{d}uₜ obtained from a measurement sensor and comparing that with the quantity σ_{u,2.5-DOF}², if the tracking control system is under feedback with the 2.5-DOF controller given in claim 9.

12. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ=yₜ^{sp}−ŷₜ) and comparing that with the quantity σ_{y,2.5-DOF}², if the tracking control system is under feedback with the 2.5-DOF controller given in claim 9.

13. A method to obtain the parameters of the quadratic performance, infinite steps stochastic regulating controller for a regulating control system described by the Box-Jenkins control model.

14. A method to verify the quadratic performance, infinite steps stochastic regulating controller of a regulating control system by comparing the performance index value of this controller given by the quantity \hat{σ}_{lqg}² and the sum of the quantities σ_{y,lqg}² and λσ_{u,lqg}².

15. An on-line method to verify the plant and disturbance models of a stochastic regulating control system described by the Box-Jenkins model by calculating the variance of the input variable (1−z⁻¹)^{d}uₜ obtained from a measurement sensor and comparing that with the quantity σ_{u,lqg}², if the regulating control system is under feedback with the quadratic performance, infinite steps stochastic regulating controller given in claim 13.

16. An on-line method to verify the plant and disturbance models of a stochastic regulating control system described by the Box-Jenkins model by calculating the variance of the output variable yₜ obtained from a measurement sensor and comparing that with the quantity σ_{y,lqg}², if the regulating control system is under feedback with the quadratic performance, infinite steps stochastic regulating controller given in claim 13.
